(19) United States
(12) Patent Application Publication
(10) Pub. No.: US 2009/0049397 A1
(43) Pub. Date: Feb. 19, 2009

(54) System And Method For A Simple Graphical Interface

(76) Inventor: Mikhail Boukhny, Laguna Niguel, CA (US)

Correspondence Address: ALCON, IP LEGAL, TB4-8, 6201 SOUTH FREEWAY, FORT WORTH, TX, 76134, US

(21) Appl. No.: 11/838,994

(22) Filed: Aug. 15, 2007

(51) Int. Cl. G06F 3/048

(52) U.S. Cl. 715/778

(57) ABSTRACT

Embodiments of systems and methods for a simplified interface are disclosed. More specifically, embodiments of modes of interaction with a surgical console may be provided such that these modes of interaction limit or curtail the range of functionality which may be adjusted. In particular, certain embodiments may present one or more interfaces for user interaction which allow a user to select from a set of preprogrammed options, where the interface or the set of preprogrammed options may correspond to the mode in which a user is interacting with the surgical console. Each of these preprogrammed options may correspond to settings for one or more parameters such that by selecting a preprogrammed option the surgical console is configured according to these settings.

### BACKGROUND

The present invention relates to surgical systems. More particularly, embodiments of the present invention relate to ophthalmic surgical systems. Even more particularly, embodiments of the present invention relate to systems and methods for configuring an ophthalmic surgical system.

The human eye can suffer a number of maladies causing mild deterioration to complete loss of vision. While contact lenses and eyeglasses can compensate for some ailments, ophthalmic surgery is required for others. Generally, ophthalmic surgery is classified into posterior segment procedures, such as vitreoretinal surgery, and anterior segment procedures, such as cataract surgery. More recently, combined anterior and posterior segment procedures have been developed.

The surgical instrumentation used for ophthalmic surgery can be specialized for anterior segment procedures or posterior segment procedures or support both. Such surgical instrumentation can comprise a Vitreoretinal and Cataract microsurgical console. Such a surgical console can provide a variety of functions depending on the surgical procedure and surgical instrumentation. For example, surgical consoles can expedite cataract surgeries (e.g. phacoemulsification procedures) by helping manage irrigation and aspiration flows into and out of a surgical site. And of course surgical consoles can provide other functions.

Thus, Vitreoretinal and Cataract surgical consoles usually have a large set of functionality, such as vitreous cutting, vacuum, etc. and commensurately are amenable to a large degree of customization. In other words, each of the parameters of such a surgical console may be individually adjusted to achieve desired settings. While at first blush this myriad number of configuration permutations might seem to be advantageous this ability may, however, in many cases cause a whole host of problems. For example, doctors may have to adjust each of multiple parameters individually during the course of performing a surgery, consuming valuable time. Furthermore, the adjustment of these parameters may need to be coordinated (e.g. the setting of one parameter depends at least in part on the settings of one or more other parameters) for best performance or to avoid possible injury or complications. This requirement may mean that settings corresponding to multiple parameters may need to be verified, calculated or adjusted even if a doctor is concerned only with a single parameter. Not only do these adjustments consume more time, but in addition, they may increase the chances of mistakes being made in the configuration of the surgical console, which, in some instances, may lead to injury of a patient or a doctor performing a surgical procedure.

Therefore there is a need for a simple system or method for configuring a surgical console.

### SUMMARY OF THE INVENTION

Embodiments of systems and methods for a simplified interface are disclosed. More specifically, embodiments of modes of interaction with a surgical console may be provided such that these modes of interaction limit or curtail the range of functionality which may be adjusted. In particular, certain embodiments may present one or more interfaces for user interaction which allow a user to select from a set of pre-programmed options, where the interface or the set of preprogrammed options may correspond to the mode in which a user is interacting with the surgical console. Each of these preprogrammed options may correspond to settings for one or more parameters. By allowing a user to select from a variety of preprogrammed options, the potential for mistakes and injury are reduced as the settings for each of the preprogrammed options may ensure that the settings for each of the parameters are proper relative to the settings for the other parameters and may similarly ensure that the values for certain parameters may not be set outside of a certain range. Additionally, as the set of parameters are adjusted in tandem according to preprogrammed settings, the interface for a particular mode of operation may be dramatically simplified relative to an interface which forces a doctor to adjust individually each parameter. Embodiments of the present invention may provide the additional advantages that the interface may be simpler and more intuitive, allowing navigation of the display to similarly be simpler (e.g. requiring fewer interactions with an input device such as a footswitch or the like) and allowing a surgical procedure to be more easily conducted.

Certain embodiments of the present invention may use a touch screen to present an interactive graphical user interface (“GUI”) to the user. Specifically, the user can use the interactive to select a mode of operation. Based upon the mode of operation selected the GUI may present interface which presents the user with the values of the current settings of a set of parameters. The interface may allow a user to easily cycle through sets of preprogrammed options, for example by using touch screen, a foot pedal control or the like, and reflects changes to the settings of the parameters displayed which correspond to the currently selected preprogrammed option.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE FIGURES

A more complete understanding of the present invention and the advantages thereof may be acquired by referring to the following description, taken in conjunction with the accompanying drawings in which like reference numbers indicate like features and wherein:

FIG. 1 is a diagrammatic representation of one embodiment of a surgical console.

FIG. 2 is a representation of one embodiment of a graphical user interface (GUI).

FIG. 3 is a representation of one embodiment of a graphical user interface (GUI).

FIG. 4 is a representation of a color palette.

FIG. 5 is a representation of one embodiment of a graphical user interface (GUI).

### DETAILED DESCRIPTION

Preferred embodiments of the invention are illustrated in the FIGURES, like numerals being used to refer to like and corresponding parts of the various drawings.

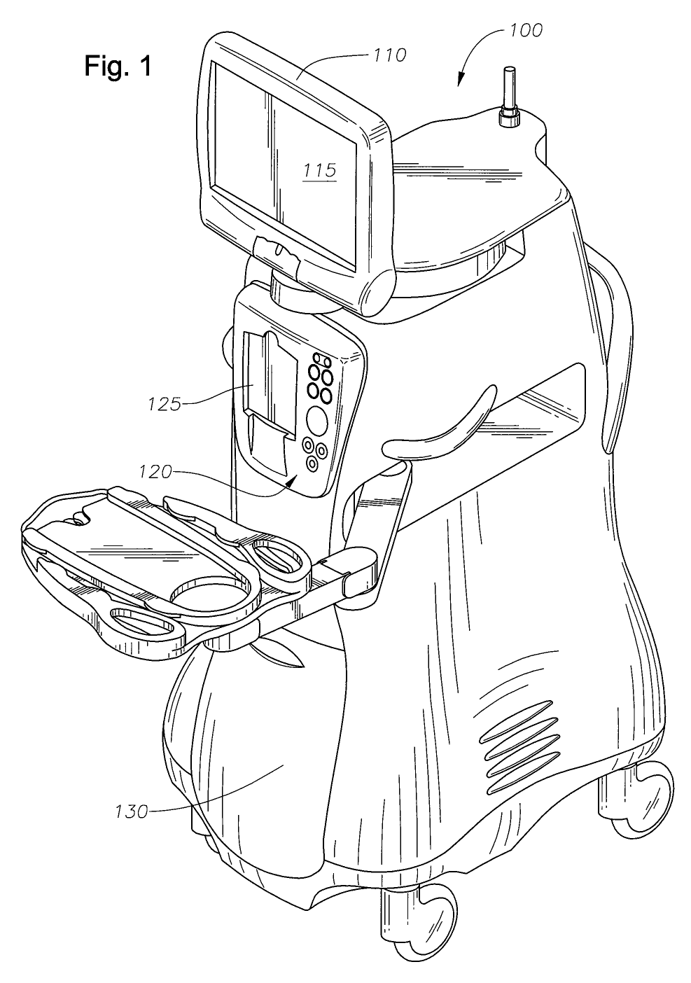

Before elaborating on various embodiments of the present invention it may be helpful to illustrate surgical console with which embodiments of the present invention may be utilized. FIG. 1 is a diagrammatic representation of one embodiment of an ophthalmic surgical console 100. Surgical console 100 can include a swivel monitor 110 that has touch screen 115. Swivel monitor 110 can be positioned in a variety of orientations for whomever needs to see touch screen 115. Swivel monitor 110 can swing from side to side, as well as rotate and tilt. Touch screen 115 provides a GUI that allows a user to interact with console 100.

Surgical console 100 also includes a connection panel 120 used to connect various tools and consumables to surgical console 100. Connection panel 120 can include, for example, a coagulation connector, balanced salt solution receiver, connectors for various hand pieces and a fluid management system (“FMS”) or cassette receiver 125. Surgical console 100 can also include a variety of user friendly features, such as a foot pedal control (e.g., stored behind panel 130) and other features.

Surgical console 100 is provided by way of example and embodiments of the present invention can be implemented with a variety of surgical systems. Example surgical systems in which various embodiments of the present invention can be used include, for example, the Series 2000® Legacy® cataract surgical system, the Accurus® 400VS surgical system, the Infiniti™ Vision System surgical system available from Alcon Laboratories Inc. of Fort Worth, Tex. Embodiments of the present invention can be implemented in other suitable surgical systems having a touch screen as would be understood by one of ordinary skill in the art.

In operation, a Graphical User Interface (GUI) may be displayed on screen 115, such that a user may interact with the surgical console 100. In one embodiment, the GUI for surgical system may allow a user to modally interact with surgical console 100. In other words, the GUI may present a user of surgical console 100 a set of icons or buttons corresponding to the entire range of functionality of surgical console 100 where the user can select from these function icons in order to utilize a particular functionality of surgical console 100. The user can then configure any parameters or sub-modes for the desired functionality and utilize this functionality. Thus, during a surgical procedure, for each step of the surgical procedure a user must manually interact with surgical console 100 to select the functionality desired for the step and configure any parameters or sub-modes for the step. As can be seen then, modal interaction with surgical console 100 may require a relatively large number of inputs (e.g. from foot pedal control or touch screen 115) to implement a surgical procedure and the GUI (or other method of interaction) with surgical console 100 may be quite cluttered and busy as it present the user with a wide variety of options corresponding to the entire range of functionality of surgical console 100.

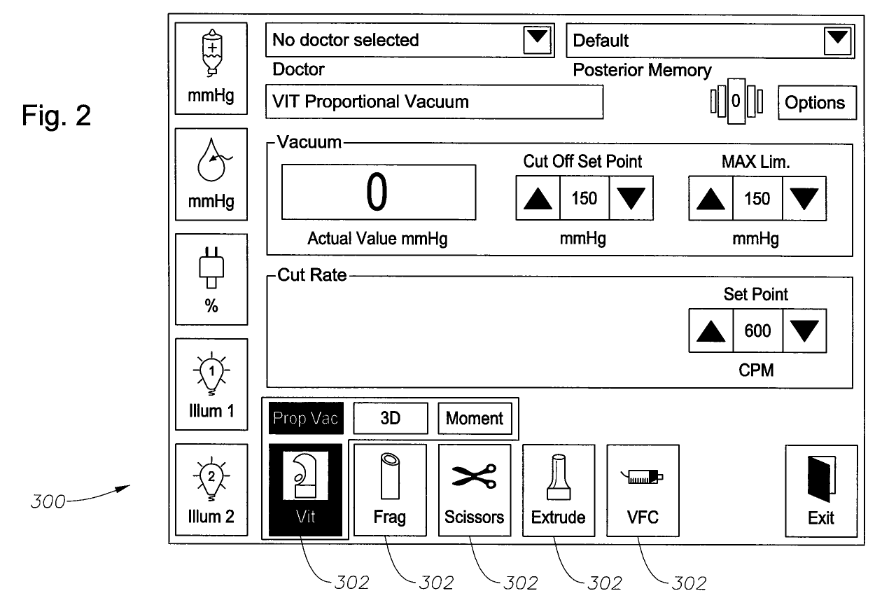

For example, surgical console 100 may include functionality for vitreous cutting (Vit), vacuum (Extraction), Scissors, Viscous Fluid Control (VFC) and ultrasonic lens removal (Fragmatome). One embodiment of a GUI for modal based interaction with such a surgical console 100 is depicted in FIG. 2. Notice that GUI 300 presents icons 302 where each of icons 302 corresponds to one function of surgical console 100. Consequently, to utilize functionality represented by icons 302 a user of surgical console 100 may select the desired icon 302. To implement a surgical procedure then, for each step the icon 302 representing functionality desired for that step may be selected, and any parameters or sub-modes for that functionality configured. At every subsequent step of the surgical procedure where functionality of surgical console 100 is desired the user must again select the desired functionality corresponding to the step from icons 202 and configure any parameters or sub-modes. As may be imagined this is an inefficient method of interacting with surgical console, as extraneous interactions are needed to select and utilize desired functionality.

What is desired then is a simple method of interacting with, and configuring, a surgical console. To that end, attention is now directed to systems and methods for a simplified interface. More specifically, embodiments of modes of interaction with a surgical console may be provided such that these modes of interaction limit or curtail the range of functionality which may be adjusted. In particular, certain embodiments may present one or more interfaces for user interaction which allow a user to select from a set of pre-programmed options, where the interface or the set of preprogrammed options may correspond to the mode in which a user is interacting with the surgical console. Each of these preprogrammed options may correspond to settings for one or more parameters. By allowing a user to select from a variety of preprogrammed options, the potential for mistakes and injury are reduced as the settings for each of the preprogrammed options may ensure that the settings for each of the parameters are proper relative to the settings for the other parameters and may similarly ensure that the values for certain parameters may not be set outside of a certain range. Additionally, as the set of parameters are adjusted in tandem according to preprogrammed settings, the interface for a particular mode of operation may be dramatically simplified relative to an interface which forces a doctor to adjust individually each parameter.

More specifically, embodiments of the present invention may use touch screen 115 to present an interactive graphical user interface (“GUI”) to the user. Specifically, the user can use the interactive to select a mode of operation. Based upon the mode of operation selected the GUI may present interface which presents the user with the values of the current settings of a set of parameters. The interface may allow a user to easily cycle through the set of preprogrammed options, for example by using touch screen 115, a foot pedal control or the like, and reflects changes to the settings of the parameters displayed which correspond to the currently selected preprogrammed option.

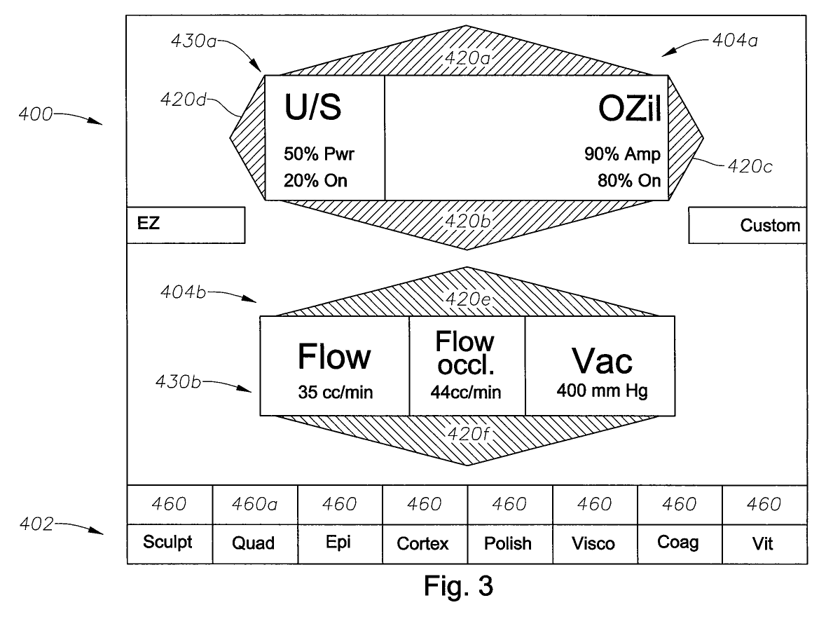

Embodiments of just such a type of simplified GUI may be described in more detail with respect to FIG. 3, which depicts one embodiment of a GUI which presents a user with the ability to cycle through a set of preprogrammed options. GUI 400 comprises mode menu 402 comprising a set of buttons 460 from which a mode of operation may be selected for the surgical console with which GUI 400 is being utilized. GUI 400 may also comprise portions 404, each portion corresponding to certain functionality and one or more parameters associated with that functionality. For example, ultrasound portion 404a may be selection or manipulation of ultrasound settings of the surgical console and fluidics portion 404b for manipulation of fluidics settings of the surgical console. Each portion 404 of the interface 400 may also have a display portion 430 which displays the current settings of one or more parameters corresponding to the functionality of that portion of the interface 400 (e.g. display 430a displays settings for parameters corresponding to ultrasound functionality, display 430b displays settings for parameters corresponding to fluidics functionality, etc.).

Each portion 404 of the interface 400 also has one or more icons 420 which allow settings corresponding to one or more of the parameters associated with the functionality of the portion to be manipulated. In one embodiment, these icons 420 may be paired and allow a user to cycle through a set of preprogrammed options for a set of one or more associated parameters where each of the preprogrammed options corresponds to settings for the set of associated parameters. In other words, by pressing one of the icons 420 a “next” preprogrammed option may be automatically selected (and the set of associated parameters configured according to the setting for the “next” preprogrammed option) while by pressing the other icon 420 of the pair the “previous” preprogrammed option may be automatically selected (and the set of associated parameters configured according to the setting for the “next” preprogrammed option). Once the user has reached the “first” or “last” of the preprogrammed option the icons may “wrap” (e.g. the “previous” option for the “first” preprogrammed option may be the “last” preprogrammed option and vice versa). Furthermore, in one embodiment, by pressing display 430 a menu comprising the entire set of preprogrammed options may be presented to a user simultaneously and a user allowed to select one of these preprogrammed options.

Thus, during use of a surgical console, a user may select a mode of operation for the surgical console from mode menu 402. Utilizing a corresponding portion of the display a user may select from one or more sets of preprogrammed options associated with the selected mode. Each of the sets of preprogrammed option may be cycled through using one or more corresponding icons (where each of the corresponding icons may be oriented along differing axis. In this way, the set of parameters are adjusted in tandem according to preprogrammed settings, reducing the potential for mistakes and injury.

A specific example may be helpful here in illustrating an embodiment of the simplified GUI described above. Suppose that a user selects quadrant mode by pressing button 460a of mode menu 402. In this mode of operation (e.g. quadrant mode) ultrasound portion 404a comprises paired icons 420a and 420b oriented along the vertical axis of GUI 400 and corresponding to the preprogrammed options (e.g. settings for corresponding parameters):

| | | | | |
|---|---|---|---|---|
| U/S 1 | US 30% | 10% On | OZil 50% | 90% On |
| U/S 2 | US 40% | 15% On | OZil 70% | 85% On |
| U/S 3 | US 50% | 20% On | OZil 90% | 80% On |
| U/S 4 | US 0% | 0% On | OZil 100% | 100% On |
| U/S 5 | US 60% | 20% On | OZil 100% | 80% On |

Ultrasound sets of settings here are called out here as U/S1, U/S2, etc. Notice that currently display displays that the currently theses parameters are configured according to the preprogrammed option: “US 50%, 20% On, OZil 90%, 80% On”. Thus, pressing icon 420a will cause the “next” preprogrammed option of “US 40%, 15% On, OZil 70%, 85% On” to be selected and the surgical console to be configured according to this preprogrammed option (and display 430a to change to display the current settings for the parameters) while pressing icon 420b will cause the “previous” preprogrammed option of “US 0%, 0% On, OZil 100%, 100% On” to be selected and the surgical console to be configured according to this preprogrammed option (and display 430a to change to display the current settings for the parameters). In one embodiment, by interacting with (e.g. pressing) display 430a the entire set of these preprogrammed options may be displayed to the user (e.g. in a drop down menu or the like) and the user allowed to select one of the options, alleviating the need for a user to manually cycle through each of the individual preprogrammed options using icons 420.

Similarly, paired icons 420c and 420d oriented along the horizontal axis of GUI 400 and corresponding to a set of preprogrammed options, where each of the preprogrammed options corresponds to a the same overall duty cycle, but a difference of 5% in the U/S Time On and OZil time On. Thus, pressing icon 420c may cause the “next” programmed option to be selected (which maintains the same overall duty cycle but reduces U/S Time On by 5% and increase OZil time On by 5%) and the surgical console to be accordingly configured, while pressing the other paired icon 420d may cause the “previous” preprogrammed option to be selected (which may maintain the same overall duty cycle, but increases U/S Time On by 5% and decrease OZil time On by 5%) and the surgical console to be accordingly configured).

Additionally, in the quadrant mode of operation fluidics portion 404b comprises paired icons 420e and 420f oriented along the vertical axis of GUI 400 and corresponding to the preprogrammed options (e.g. settings for corresponding parameters):

| | | |
|---|---|---|
| F 1 | Flow 23/23 cc/min | Vacuum 200 mm Hg |
| F 2 | Flow 27/35 cc/min | Vacuum 250 mm Hg |
| F 3 | Flow 31/40 cc/min | Vacuum 300 mm Hg |
| F 4 | Flow 35/44 cc/min | Vacuum 400 mm Hg |
| F 5 | Flow 40/55 cc/min | Vacuum 500 mm Hg |
| F 6 | Flow 45/70 cc/min | Vacuum 600 mm Hg. |

Fluidics sets of settings are called out here as F1,F2, etc.

Notice that currently display displays that the currently theses parameters are configured according to the preprogrammed option: “Flow 35/44 cc/min, Vacuum 400 mm Hg”. Thus, pressing icon 420e will cause the “next” preprogrammed option of “Flow 31/40 cc/min, Vacuum 300 mm Hg” to be selected and the surgical console to be configured according to this preprogrammed option (and display 430b to change to display the current settings for the parameters) while pressing icon 420f will cause the “previous” preprogrammed option of “Flow 40/55 cc/min, Vacuum 500 mm Hg” to be selected and the surgical console to be configured according to this preprogrammed option (and display 430a to change to display the current settings for the parameters). In one embodiment, by pressing display 430b the entire set of these preprogrammed options may be displayed to the user and the user allowed to select one of the options, alleviating the need for a user to manually cycle through each of the individual preprogrammed options using icons 420.

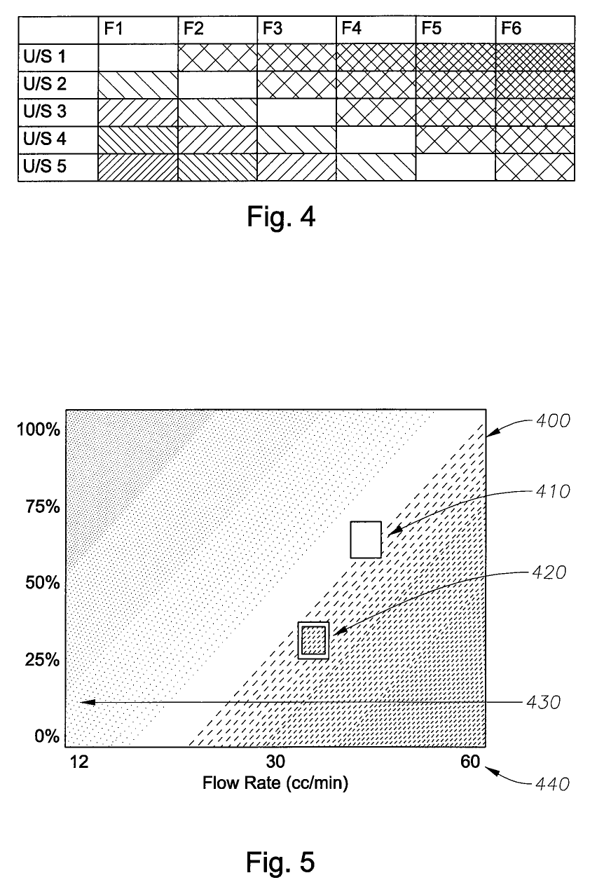

Alternatively, in one embodiment, instead of the drop down menu for a set of parameters a two-dimensional interface can be presented to the user. The cells corresponding to various combinations of parameters can be color coded to reflect expected increase in temperature which is approximately proportional to the amount of ultrasound and inversely proportional to the flow rate. Thus higher ultrasound values corresponding to low flow rates may be color coded as “hotter” colors, while lower ultrasound values and higher flow rater can be color coded as “colder” colors as presented in the example of FIG. 4.

One embodiment of just such an interface is depicted in FIG. 5. Control field 400 may be presented to allow a user to control instantaneous average power 430 and instantaneous flow rate 440. More particularly in field 400, the blue-red gradient is an estimation of incision temperature increase after a duration (which may be specified by a user or otherwise specified). Blue represents a lower temperature increase while red indicates a greater temperature increase. A user may control the field by dragging a requested settings icon 410 and is given real time feedback through a similar looking current settings icon 420 which also indicates an instantaneous incision temperature (e.g. based on foot switch penetration). Thus, feedback is provided to a user of surgical console 100 (e.g. instantaneous incision temperatures) through touch screen interface 115.

It may further be useful to an understanding of a particular embodiment of such a simplified interface to provide example preprogrammed options for different surgical steps. It will be noted that these preprogrammed options and surgical steps are exemplary only and that a wide variety of fewer, additional or other preprogrammed options may be utilized or implemented in conjunction with each of the listed modes or operation and that other modes of operation and sets of preprogrammed options are contemplated. For example:

### Surgical Mode: Sculpting

### Ultrasound

In one embodiment, for this set of preprogrammed options there may be pulse mode only with the 20 pps, total of 100% duty cycle—no off time.

US 30%, 10% On, OZil 50%, 90% On

US 40%, 15% On, OZil 70%, 85% On

US 50%, 20% On, OZil 90%, 80% On

US 0%, 0% On, OZil 100%, 100% On

US 60%, 20% On, OZil 100%, 80% On

### Fluidics

In one embodiment, for this set of preprogrammed options dynamic rise is 0

Flow 17 cc/min, Vacuum 50 mm Hg

Flow 19 cc/min, Vacuum 70 mm Hg

Flow 21 cc/min, Vacuum 90 mm Hg

Flow 23 cc/min, Vacuum 120 mm Hg

Flow 25 cc/min, Vacuum 250 mm Hg

### Surgical Mode: Quadrant Removal or Chop

### Ultrasound

In one embodiment, for this set of preprogrammed options, it may be pulse mode only with the 8 pps, total of 100% duty cycle—no off time.

US 30%, 10% On, OZil 50%, 90% On

US 40%, 15% On, OZil 70%, 85% On

US 50%, 20% On, OZil 90%, 80% On

US 0%, 0% On, OZil 100%, 100% On

US 60%, 20% On, OZil 100%, 80% On

### Fluidics

In one embodiment, for this set of preprogrammed options both flow and vacuum are fixed

Flow 23/23 cc/min, Vacuum 200 mm Hg

Flow 27/35 cc/min, Vacuum 250 mm Hg

Flow 31/40 cc/min, Vacuum 300 mm Hg

Flow 35/44 cc/min, Vacuum 400 mm Hg

Flow 40/55 cc/min, Vacuum 500 mm Hg

Flow 45/70 cc/min, Vacuum 600 mm Hg

Flow 50/90 cc/min, Vacuum 700 mm Hg

Flow 60/100 cc/min, Vacuum unlimited

### Surgical Mode: Epinucleus

### Ultrasound

In one embodiment, for this set of preprogrammed options the options may be continuous only, no U/S, only OZil

OZil 20%

OZil 40%

OZil 60%

### Surgical Mode: Fluidics

In one embodiment, for this set of preprogrammed options flow may always be fixed, vacuum may always linear and dynamic rise may be always 0 (e.g. no change in pump speed on occlusion).

Flow 23 cc/min, Vacuum 150 mm Hg

Flow 27 cc/min, Vacuum 200 mm Hg

Flow 31 cc/min, Vacuum 250 mm Hg

Flow 35 cc/min, Vacuum 300 mm Hg

Flow 40 cc/min, Vacuum 400 mm Hg

Flow 45 cc/min, Vacuum 500 mm Hg

Although the present invention has been described in detail herein with reference to the illustrated embodiments, it should be understood that the description is by way of example only and is not to be construed in a limiting sense. It is to be further understood, therefore, that numerous changes in the details of the embodiment of this invention and additional embodiments of this invention will be apparent, and may be made by, persons of ordinary skill in the art having reference to this description. It is contemplated that all such changes and additional embodiments are within scope of the invention as claimed below.

1. A method for conducting a surgical procedure, comprising:
providing a GUI for a surgical console, wherein the first GUI comprises a set of portions, each portion corresponding to functionality of the surgical console and configured to allow a user to select from each of one or more corresponding sets of preprogrammed options, each of the preprogrammed options corresponding to settings for one or more corresponding parameters; and
configuring the surgical console according to the selected preprogrammed option.

2. The method of claim 1, wherein each portion has one or more icons, the one or more icons configured to allow a user to cycle through one of the corresponding sets of preprogrammed options.

3. The method of claim 2, wherein the one or more icons are a pair of icons.

4. The method of claim 3, wherein each portion comprise a display, where the display is configured to allow a user to select one of the preprogrammed options from all of the preprogrammed options of one of the corresponding sets of preprogrammed options.

5. The method of claim 1, wherein a first portion of the set of portions is an ultrasound portion.

6. The method of claim 5, wherein the first portion comprises a first pair of icons oriented along a first axis and configured to allow a user to cycle through a first set of preprogrammed options to select one of the first set of preprogrammed options such that the surgical console is configured according to the one of the first set of preprogrammed options.

7. The method of claim 6, wherein the first portion comprises a second pair of icons oriented along a second axis configured to allow a user to cycle through a second set of preprogrammed options to select one of the second set of preprogrammed option such that the surgical console is configured according to the one of the second set of preprogrammed options

8. The method of claim 7, wherein a second portion of the set of portions is a fluidics portion.

9. The method of claim 8, wherein the second portion comprises a third pair of icons oriented along a first axis configured to allow a user to cycle through a third set of preprogrammed options to select one of the third set of preprogrammed option such that the surgical console is configured according to the one of the third set of preprogrammed options.

10. A computer readable medium comprising a set of computer instructions, translatable for:
providing a GUI for a surgical console, wherein the first GUI comprises a set of portions, each portion corresponding to functionality of the surgical console and configured to allow a user to select from each of one or more corresponding sets of preprogrammed options, each of the preprogrammed options corresponding to settings for one or more corresponding parameters; and
configuring the surgical console according to the selected preprogrammed option.

11. The computer readable medium of claim 10, wherein each portion has one or more icons, the one or more icons configured to allow a user to cycle through one of the corresponding sets of preprogrammed options.

12. The computer readable medium of claim 11, wherein the one or more icons are a pair of icons.

13. The computer readable medium of claim 12, wherein each portion comprise a display, where the display is configured to allow a user to select one of the preprogrammed options from all of the preprogrammed options of one of the corresponding sets of preprogrammed options.

14. The computer readable medium of claim 13, wherein the display allows the user to select the one of the preprogrammed options using a drop down menu.

15. The computer readable medium of claim 10, wherein a first portion of the set of portions is an ultrasound portion.

16. The computer readable medium of claim 15, wherein the first portion comprises a first pair of icons oriented along a first axis and configured to allow a user to cycle through a first set of preprogrammed options to select one of the first set of preprogrammed options such that the surgical console is configured according to the one of the first set of preprogrammed options.

17. The computer readable medium of claim 16, wherein the first portion comprises a second pair of icons oriented along a second axis configured to allow a user to cycle through a second set of preprogrammed options to select one of the second set of preprogrammed option such that the surgical console is configured according to the one of the second set of preprogrammed options

18. The computer readable medium of claim 17, wherein a second portion of the set of portions is a fluidics portion.

19. The computer readable medium of claim 18, wherein the second portion comprises a third pair of icons oriented along a first axis configured to allow a user to cycle through a third set of preprogrammed options to select one of the third set of preprogrammed option such that the surgical console is configured according to the one of the third set of preprogrammed options.

20. The method of claim 4, wherein the display allows the user to select the one of the preprogrammed options using a drop down menu.
